(19) United States
(12) Patent Application Publication
(10) Pub. No.: US 2005/0099665 A1
(43) Pub. Date: May 12, 2005

(54) Frequency tunable resonant scanner

(75) Inventors: Ju-hyun Lee, Seoul (KR); Jin-woo Cho, Gyeonggi-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 10/963,833

(22) Filed: Oct. 14, 2004

(30) Foreign Application Priority Data
Nov. 6, 2003 (KR) 10-2003-0078325

(51) Int. Cl. H02P 5/46; G02B 26/08

(52) U.S. Cl. 359/213; 359/223

(57) ABSTRACT

Provided is a one-axis driving optical scanner including a substrate, a stage separated a predetermined height from the substrate and having an optical scanning surface formed on an upper surface thereof, a plurality of first driving comb electrodes extending from opposite sides of the stage, a first anchor separated a predetermined distance from the opposite sides of the stage and fixed on the substrate and having a plurality of first fixed comb electrodes arranged at one side thereof to be alternate with the first driving comb electrodes, at least one first bending spring having one end connected to a center portion of each of another opposite sides of the stage, an inertia portion separated a predetermined distance above the substrate, in which the other end of the first bending spring is connected to a center portion of one side thereof, a second anchor fixed on the substrate at opposite sides of the first anchor, a second bending spring connecting the inertia portion and the second anchor, and an inertia portion pulling unit to pull the inertia portion in a direction opposite to the first bending spring.

This application claims the priority of Korean Patent Application No. 2003-78325, filed on Nov. 6, 2003, in the Korean Intellectual Property Office, the disclosure of which is incorporated herein in its entirety by reference.

### BACKGROUND OF THE INVENTION

1. Field of the Invention

The present invention relates to an optical scanner having a frequency tunable micro electro-mechanical system (MEMS) structure, and more particularly, to an optical scanner in which a resonant frequency of the optical scanner is increased by increasing a spring constant of a support spring of a horizontal deformation stage.

2. Description of the Related Art

Scanners having an MEMS structure to deflect a laser beam is used in projection TVs. In the MEMS type scanner, when a stage is driven in a range of a resonant frequency, a scanning angle of the stage increases and a driving voltage decreases.

FIG. 1 shows drive displacements at a resonant frequency in MEMS type scanners having different Q factors. Referring to FIG. 1, for a scanner having a high Q factor, when a frequency is out of a resonant frequency, the drive displacement changes much. For a scanner having a low Q factor, even when a frequency is out of the resonant frequency, the drive displacement changes slightly.

Thus, an optical scanner for a large drive displacement has a high Q factor and needs to be driven at a resonant frequency. However, even when the MEMS structure is precisely manufactured, manufacturing the actuator driven at a resonant frequency is very difficult due to a deviation in process.

U.S. Pat. No. 6,535,325 discloses a method of controlling a resonant frequency of an optical scanner having an MEMS structure. That is, the patent discloses a method of driving an optical scanner by installing a plurality of tuning tabs at edge portions of a stage and removing the tabs using a laser trimming or a mechanical force while measuring a frequency so that the weight of a mirror body is reduced and thus a resonant frequency is increased.

### SUMMARY OF THE INVENTION

To solve the above and/or other problems, the present invention provides a frequency tunable resonant frequency having a unit to increase a spring constant of a spring to support a stage so that the frequency of the stage can be controlled during driving of the optical scanner.

According to an aspect of the present invention, a one-axis driving optical scanner comprises a substrate, a stage separated a predetermined height from the substrate and having an optical scanning surface formed on an upper surface thereof, a plurality of first driving comb electrodes extending from opposite sides of the stage, a first anchor separated a predetermined distance from the opposite sides of the stage and fixed on the substrate and having a plurality of first fixed comb electrodes arranged at one side thereof to be alternate with the first driving comb electrodes, at least one first bending spring having one end connected to a center portion of each of another opposite sides of the stage, an inertia portion separated a predetermined distance above the substrate, in which the other end of the first bending spring is connected to a center portion of one side thereof, a second anchor fixed on the substrate at opposite sides of the first anchor, a second bending spring connecting the inertia portion and the second anchor, and an inertia portion pulling unit to pull the inertia portion in a direction opposite to the first bending spring.

The inertia portion pulling unit comprises a third anchor fixed on the substrate to be separated a predetermined distance from the inertia portion, a plurality of second driving comb electrodes extending a predetermined length from the inertia portion toward the third anchor, and a plurality of second fixed comb electrodes formed at the third anchor to be alternate with the second driving comb electrodes.

The optical scanner further comprises a voltage supply source to simultaneously apply a predetermined tuning voltage to the second fixed comb electrodes formed at the opposite sides of the stage.

When a predetermined tuning voltage is applied to the voltage supply source, a spring constant of the first bending spring increases.

The first bending spring has a plate shape in which a vertical length is greater than a horizontal width.

The first, second, and third anchors constitute a rectangular frame and are electrically separated from one another.

According to another aspect of the present invention, a one-axis driving optical scanner comprises a substrate, a stage separated a predetermined height from the substrate and having an optical scanning surface formed on an upper surface thereof, a plurality of first driving comb electrodes extending from opposite sides of the stage, a first anchor separated a predetermined distance from the opposite sides of the stage and fixed on the substrate and having a plurality of first fixed comb electrodes arranged at one side thereof to be alternate with the first driving comb electrodes, at least one first bending spring having one end connected to a center portion of each of another opposite sides of the stage, an inertia frame separated a predetermined distance above the substrate, in which the other end of the first bending spring is connected to one side thereof, and having at least two inertia portions separated from each of another opposite sides of the stage parallel to each other and a support beam connecting between the inertia portions, a second anchor fixed on the substrate to correspond to the inertia frame from opposite sides of the first anchor, a second bending spring connecting the inertia portion and an inner side of the second anchor corresponding to opposite sides of each of the inertia portions, and an inertia portion pulling unit to pull the inertia frame in a direction opposite to the first bending spring.

The inertia frame pulling unit comprises a third anchor fixed on the substrate to be separated a predetermined distance from the inertia frame at an opposite side of the stage with respect to the inertia frame, an anchor branch fixed on the substrate to extend from the inner side of the second anchor toward the support beam, a plurality of second driving comb electrodes extending a predetermined length from the inertia portions toward a direction opposite to the stage, and a plurality of second fixed comb electrodes formed on the third anchor and the anchor branch, corresponding to the second driving comb electrodes, to be alternate with the second driving comb electrodes.

The first and second anchors are electrically separated from each other and the inertia portion and the anchor branch are electrically insulated from each other.

The first, second, and third anchors constitute a rectangular frame and are electrically separated from one another.

According to yet another aspect of the present invention, a two-axes driving optical scanner comprises a substrate, a stage separated a predetermined height from the substrate and having an optical scanning surface formed on an upper surface thereof, a first support portion supporting a linear motion of the stage and including at least one first bending spring extending from opposite sides of the stage in a first direction, a first inertia portion having one side connected to the first bending spring, and a rectangular driving frame having a pair of first portions parallel to each other, to which a second bend spring extending from the other opposite sides of the first inertia portion in a second direction perpendicular to the first direction is connected, and a pair of second portions extending in the second direction parallel to each other, a stage driving portion including a plurality of first fixed comb electrodes and first driving comb electrodes formed at inner sides of the first portions and corresponding side of the stage, respectively, a second support portion including a third bending spring extending from each of the first portions of the driving frame in the second direction, a second inertia portion having one side connected to the third bending spring, and a rectangular fixed frame having a pair of second portions parallel to each other, to which a fourth bend spring extending from the other opposite sides of the second inertia portion in the first direction is connected, and a pair of first portions extending in the first direction parallel to each other, a first support portion driving portion including a plurality of third driving comb electrodes provided at the second portions of the driving frame and a plurality of third fixed comb electrodes formed at inner sides of the first portions of the fixed frame corresponding to the third driving comb electrodes, to generate a first directional excitation motion of the first support portion, and first and/or second inertial portions pulling unit to pull the first inertia portion and/or the second inertia portion in a direction opposite to the stage.

The first inertia portion pulling unit comprises a plurality of second driving comb electrodes formed at a side of the first inertia portion facing the second portion of the driving frame, and a plurality of second fixed comb electrodes formed at the driving frame to be alternate with the second driving comb electrodes.

The second inertia portion pulling unit comprises a plurality of fourth driving comb electrodes formed at a side of the second inertia portion facing the first portion of the fixed frame, and a plurality of fourth fixed comb electrodes formed at the fixed frame to be alternate with the fourth driving comb electrodes.

### BRIEF DESCRIPTION OF THE DRAWINGS

The above and other features and advantages of the present invention will become more apparent by describing in detail preferred embodiments thereof with reference to the attached drawings in which:

FIG. 1 is a graph showing drive displacements at a resonant frequency in MEMS type scanners having different Q factors;

FIG. 2 is a view for explaining a method of controlling a driving frequency of the stage;

FIG. 3 is a graph showing the result of simulation of a model of FIG. 2;

FIG. 4 is a plan view of an optical scanner according to a first embodiment of the present invention;

FIGS. 5 and 6 are sectional views taken along lines V-V and VI-VI of FIG. 4, respectively;

FIG. 7 is a plan view illustrating a structure of applying a voltage to the optical scanner of FIG. 4;

FIG. 8 is a plan view of an optical scanner according to a second embodiment of the present invention;

FIG. 9 is a sectional view taken along line IX-IX of FIG. 8;

FIG. 10 is a plan view of a two-axes driving optical scanner according to a third embodiment of the present invention; and

FIGS. 11 and 12 are sectional views taken along lines XI-XI and XII-XII of FIG. 10.

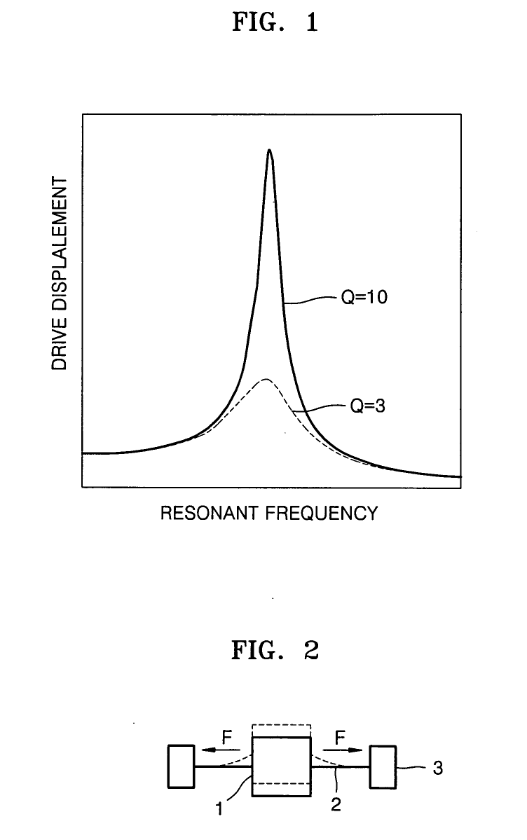

### DETAILED DESCRIPTION OF THE INVENTION

Referring to FIG. 2, a spring 2 supporting the opposite sides of a stage 1 is supported by an anchor 3. When a predetermined external force F is applied to the anchor 3 in an outward direction while driving the stage 1 at a predetermined frequency, a spring constant of the spring 2 changes. Thus, by changing the spring constant of the spring 2, a resonant frequency of the stage 1 can be controlled. Such a principle is the same as that of tuning cords of a guitar.

Thus, after the resonant frequency of the scanner is set to be lower than a desired resonant driving frequency during manufacture of the scanner, the resonant frequency of the scanner is increased through tuning so as to control the driving frequency.

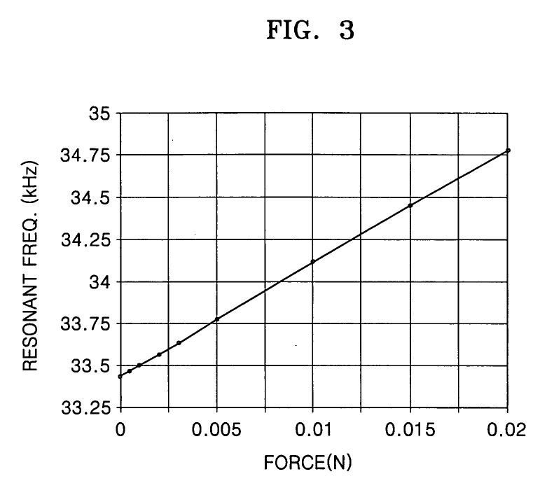

FIG. 3 is a graph showing the result of simulation of a model of FIG. 2. A stage used for the simulation has a dimension of 750 μm in width, 550 μm in height, and 45 μm in thickness. Thee springs are arranged at either side of the stage and each spring is of a plate type having a dimension of 10 μm in width, 273 μm in length, and 45 μm in height (thickness).

Referring to FIG. 3, as the external force applied to the stage at an initial frequency of 33.43 kHz is increased to 0.02 N, the frequency of the stage changes at a constant rate. Thus, in a state in which the initial frequency of the stage is set to be lower than a desired resonant frequency, for example, 33.75 kHz, when a predetermined tensile force is applied to the spring at the opposite sides of the stage, a mirror can be driven at the desired resonant frequency.

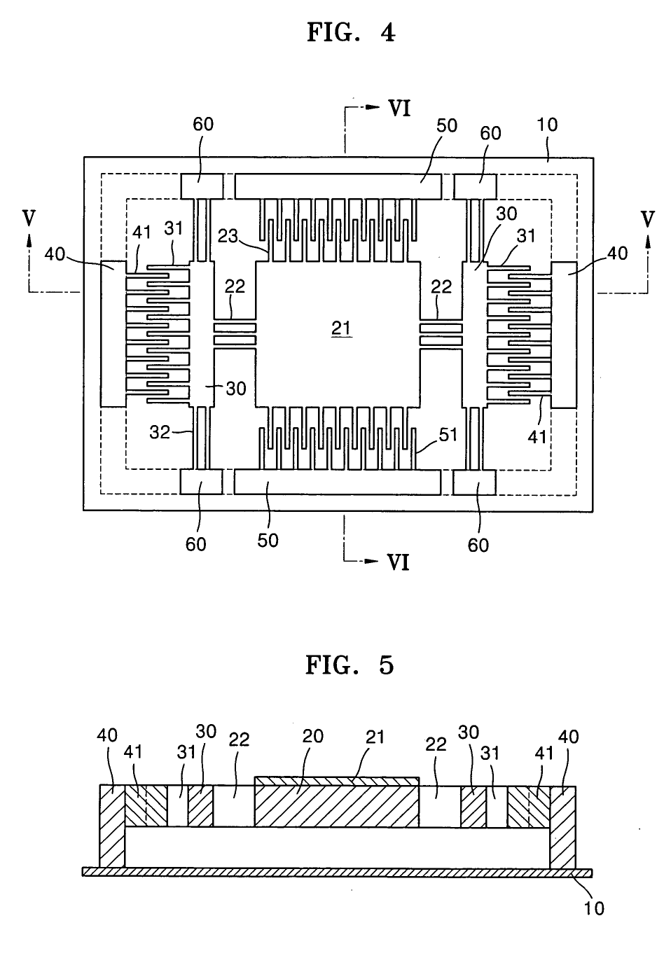

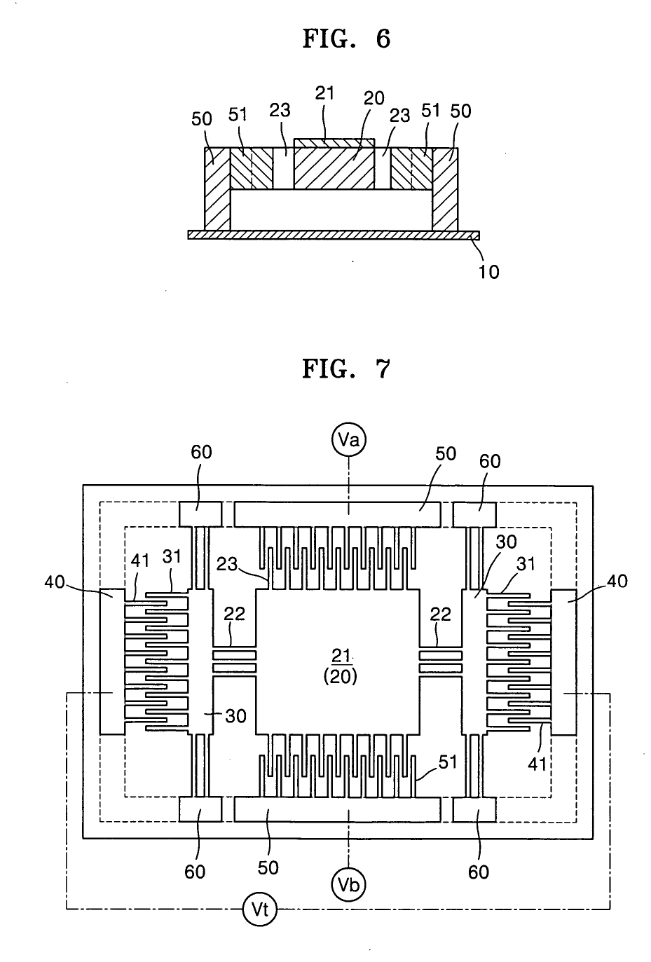

FIG. 4 is a plan view of an optical scanner according to a first embodiment of the present invention. FIGS. 5 and 6 are sectional views taken along lines V-V and VI-VI of FIG. 4, respectively.

Referring to FIGS. 4 through 6, a stage 20 is suspended by a support portion supporting the opposite sides of the stage 20, above a substrate 10 formed of pyrex glass. A mirror surface 21 that is an optical scanning surface is formed on an upper surface of the stage 20. A plurality of first driving comb electrodes 23 are formed at the opposite sides of the stage 20 to a predetermined length and parallel to one another.

A first anchor 50 is fixedly installed on the substrate 10. A plurality of first fixed comb electrodes 51 are formed one side of the first anchor 50 and alternately arranged between the first driving comb electrodes 23 of the stage 20.

The support portion includes a plurality of first bending springs 22 connected to the other opposite sides of the stage 20, an inertia portion 30 having one side connected to the first bending springs 22 and a plurality of second driving comb electrodes 31 formed at the other side thereof, and a second anchor 40 where a plurality of second fixed comb electrodes 41 alternately arranged between the second driving comb electrodes 31 are formed at one side thereof. The second driving comb electrodes 31 and the second fixed comb electrodes 41 constitute an inertia portion pulling unit which pulls the inertia portion 30 in a direction opposite to the first bending spring 22.

The first bending spring 22 preferably has a plate shape which is vertically arranged to be deformed in a horizontal direction, not in a vertical direction, by an external force. The bending spring having a plate shape is installed in multiple numbers so as to prevent a seesaw motion of the stage 20.

A third anchor 60 is fixedly installed on the substrate 10 at opposite sides of the first anchor 50 to be electrically separated from the first anchor 50. A second bending spring 32 is connected between the inertia portion 30 and the third anchor 60. Thus, the inertia portion 30 and the stage 20 are suspended from the substrate 10.

These anchors 40, 50, and 60 are preferably installed to be electrically insulated from one another. The anchors 40, 50, and 60 can be formed in a rectangular frame connected by dotted lines of FIG. 4 in a structure of being electrically insulated.

A voltage supply source to apply a tuning voltage (Vt of FIG. 7) simultaneously to the second fixed comb electrodes 41 at opposite sides of the stage 20 is preferably provided.

FIG. 7 shows the structure of applying a voltage to the optical scanner of FIG. 4. Referring to FIG. 7, the stage 20 performs a horizontal motion by an electrostatic force between the first driving comb electrodes 23 and the first fixed comb electrodes 51 disposed at opposite sides of the stage 20. For example, when a predetermined voltage Va is applied to the first fixed comb electrodes 51 disposed at the upper side of the drawing, an electrostatic force is generated between the first driving comb electrodes 23 and the first fixed comb electrodes 51 so that the first driving comb electrodes 23 are driven and thus the stage 20 is moved upward. When a predetermined voltage Vb is applied to the first fixed comb electrodes 51 disposed at the lower side of the drawing, an electrostatic force is generated by the first driving comb electrodes 23 and the first fixed comb electrodes 51 so that the stage 20 is moved downward. The stage 20 is returned to its original position by a restoration force of an elastic coefficient of the first bending spring 22. By repeatedly applying a driving voltage to the first fixed comb electrodes 51 at the upper and lower sides to alternately generate an electrostatic force, the stage 20 performs an excitation motion with a predetermined frequency. When a predetermined tuning voltage Vt is simultaneously applied to the second fixed comb electrodes 41 separated from opposite sides of the stage 20, a tensile force by which the inertia portion 30 is moved to the corresponding second anchor 40 is applied to the inertia portion 30 so that the spring constant (stiffness) of the first bending spring 22 increases. Thus, by controlling the tuning voltage Vt, the excitation frequency of the stage 20 can be set to be a resonant frequency.

Although in the above embodiment the stage 20 is described as being driven horizontally, by making the first bending spring 22 into one and applying an external force so that the stage 20 can perform a seesaw motion, the stage 20 performs a seesaw motion around the first bending spring 22 forming a center shaft so that the frequency of the stage 20 can be tunable by the tuning voltage applied to the second fixed comb electrodes 41.

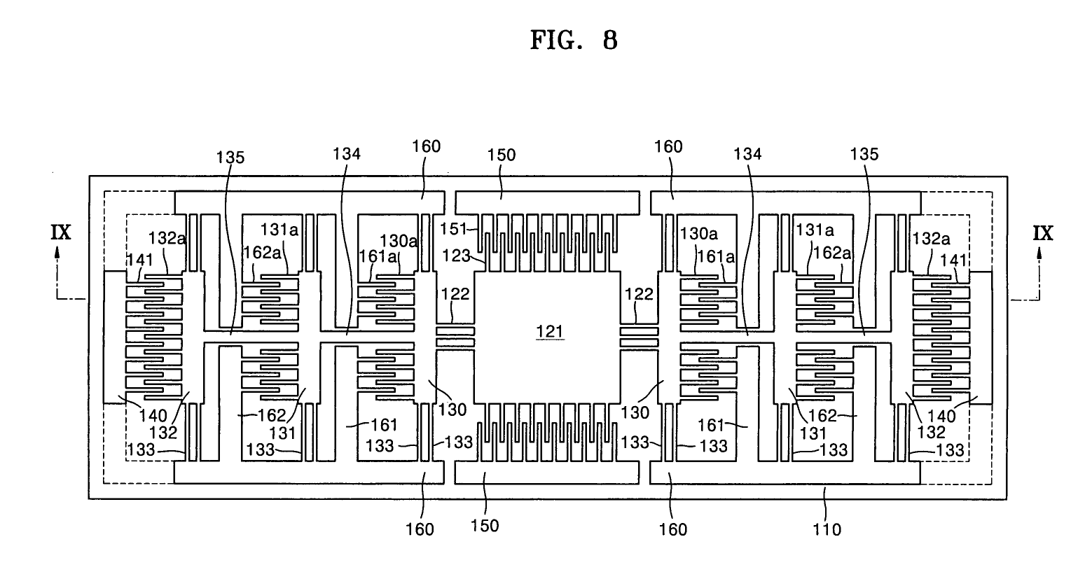

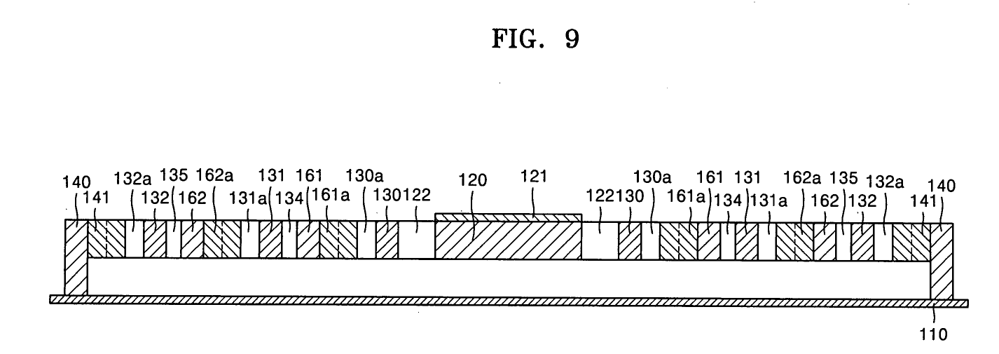

FIG. 8 is a plan view of an optical scanner according to a second embodiment of the present invention. FIG. 9 is a sectional view taken along line IX-IX of FIG. 8.

Referring to FIGS. 8 and 9, a stage 120 is suspended above a substrate 110 formed of pyrex glass, by being supported by a support portion supporting opposite sides of the stage 120. A mirror surface 121 which is an optical scanning surface is formed on an upper side of the stage 120. A plurality of first driving comb electrodes 123 are formed on opposite sides of the stage 120 to a predetermined length and parallel to one another.

The first fixed comb electrodes 151 are formed one side of a first anchor 150 fixedly supported on the substrate 110 and arranged at opposite sides of the stage 120 to be alternate with the first driving comb electrodes 123. The support portion includes a plurality of first bending springs 122 connected to the other opposite sides of the stage 120, an inertia frame having one side connected to the first bending springs 122, and a fixed frame to support the inertia frame from the substrate 110.

The inertia frame includes first, second, and third inertia portions 130, 131, and 132 parallel to one another and support beams 134 and 135 connecting the centers of the inertia portions 130, 131, and 132 between the first, second, and third inertia portions 130, 131, and 132.

The fixed frame includes a third anchor 160 fixed on the substrate 110 to be separated a predetermined distance from the opposite sides of the inertia portions 130, 131, and 132 and a second bending spring 133 connecting each of the inertia portions 130, 131, and 132 and an inner side of the third anchor 160. Anchor branches 161 and 162 extending from the third anchor 160 toward the support beams 134 and 135 between the inertia portions are fixed on the substrate 110.

A second anchor 140 is fixedly installed on the substrate 110 outside the third inertia portion 132. A plurality of second driving comb electrodes 130a, 131 a, and 132a are formed parallel to one another on the side of each of the inertia portions 130, 131, and 132 toward the second anchor 140. A plurality of second fixed comb electrodes 161a, 162a, and 141 are arranged on the corresponding anchor branches 161 and 162 and the second anchor 140 to be alternate with the second driving comb electrodes 130a, 131a, and 132a, respectively. The second driving comb electrodes 130a, 131a, and 132a and the second fixed comb electrodes 161a, 162a, and 141 constitute an inertia frame pulling unit which pulls the inertia frame in a direction opposite to the first bending spring 122.

The first bending spring 122 preferably has a plate shape which is vertically arranged to be deformed in a horizontal direction, not in a vertical direction, by an external force. The bending spring having a plate shape is installed in multiple numbers so as to prevent a seesaw motion of the stage 120.

The third anchor 160 applies a predetermined tuning voltage to the second fixed comb electrodes 161a and 162a and formed electrically insulated from the inertia portions 130, 131, and 132.

Since the optical scanner according to the second embodiment has the same structure as that of the optical scanner according to the first embodiment, except for using a plurality of the inertia portions to increase the electrostatic force acting in the direction perpendicular to a driving direction of the stage according to the first embodiment, a detailed description thereof will be omitted herein.

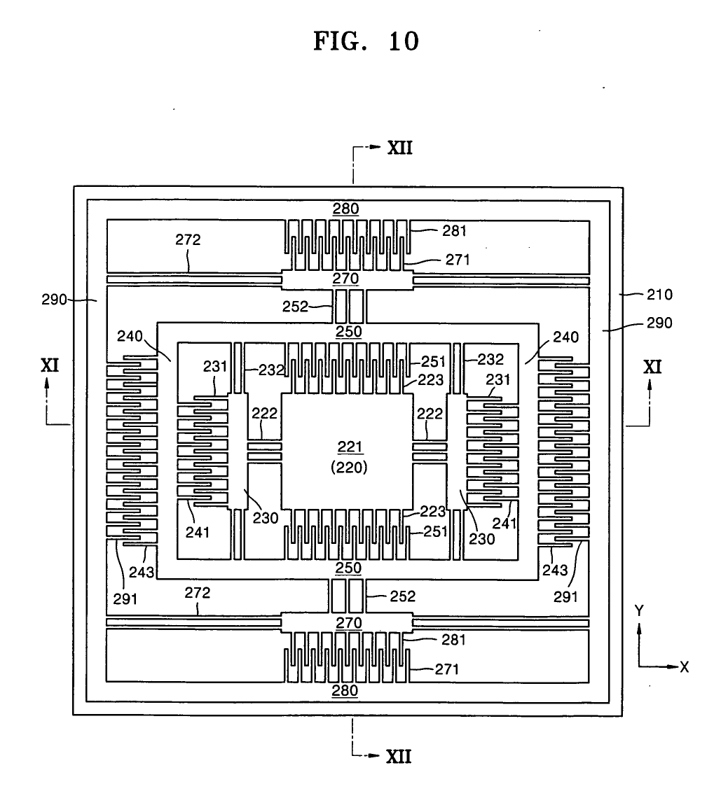

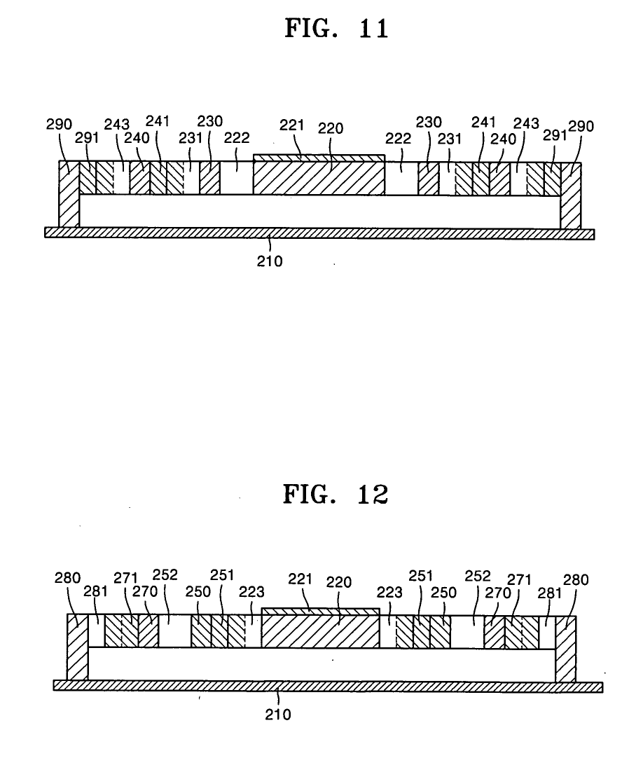

FIG. 10 is a plan view of a two-axes driving optical scanner according to a third embodiment of the present invention. FIGS. 11 and 12 are sectional views taken along lines XI-XI and XII-XII of FIG. 10.

Referring to FIGS. 10 through 12, a stage 220 is supported by a first support portion including a plurality of first bending springs 222 and a rectangular driving frame, above a substrate 210 formed of pyrex glass, to be capable of exciting in a second direction (Y axis direction). The first support portion including the stage 220 is supported by a second support portion including a third bending spring 252 and a rectangular driving frame 240 and 250, to be capable of exciting in a first direction (X axis direction). Thus, the stage 220 is supported to be capable of moving in two-axes directions by the first and second support portions. A mirror surface 221 that is an optical scanning surface is formed on an upper surface of the stage 220 and a plurality of first driving comb electrodes 223 are formed on the opposite sides of the stage 220 to a predetermined length and parallel to one another.

A third bending spring 252 which will be described later is connected to the middle of the rectangular driving frame 250. The rectangular driving frame includes two first portions 250 extending parallel to the X axis direction and two second portions 240 extending parallel to the Y axis direction. A plurality of first fixed comb electrodes 251 are formed at each of the first portions 250 of the rectangular driving frame, to be alternate with the first driving comb electrodes 223 of the opposite sides of the stage 220. The first driving comb electrodes 223 and the first fixed comb electrodes 251 constitute a stage driving portion.

The first bending springs 222 connected to the opposite sides of the stage 220 are connected to one side of each of two first inertia portions 230. A plurality of second driving comb electrodes 231 are formed at the other side of each of the first inertia portions 230. The other opposite sides of each of the first inertia portions 230 are connected to the inner sides of the first portions 250 of the rectangular driving frame by a plurality of second bending springs 232. A plurality of second fixed comb electrodes 241 are formed on the inner sides of the second portions 240 of the rectangular driving frame, to be alternate with the second driving comb electrodes 231. The second driving comb electrodes 231 and the second fixed comb electrodes 241 constitute a first inertia pulling unit to pull the first inertia portion 230 in a direction opposite to the stage 220.

A rectangular fixed frame which encompass the rectangular driving frame has first portions 280 extending in a first direction and second portions 290 extending in a second direction and is fixedly installed on the substrate 210. A plurality of third driving comb electrodes 243 are arranged at an outer side of each of the second portions 240 of the driving frame. A plurality of third fixed comb electrodes 291 are arranged on an inner side of each of the second portions 290 of the rectangular fixed frame to be alternate with the third driving comb electrodes 243. The third driving comb electrodes 243 and the third fixed comb electrodes 291 constitute a first support portion driving portion.

A third bending spring 252 connected to the center portion of the outer side of each of the first portions 250 of the driving frame is connected to one side of the second inertia portion 270. A fourth bending spring 272 is connected to the other sides of the second inertia portion 270 and the inner side of each of the second portions 290 of the fixed frame. A plurality of fourth fixed comb electrodes 281 are formed on the inner side of each of the first portions 290 of the fixed frame to be alternate with the fourth driving comb electrodes 271. The fourth driving comb electrodes 271 and the fourth fixed comb electrodes 281 constitute a second inertia portion pulling unit which pulls the second inertia portion 270 in a direction opposite to the stage 220.

The fixed frame and the driving frame are preferably manufactured such that portions thereof which contact the respective fixed comb electrodes 251, 241, 281, and 291 are electrically conductive and electricity is applied to the first and second fixed comb electrodes 251 and 241 separately through the third bending spring 252. Since the techniques to form insulation and conductive structures are well known, a detailed description thereof will be omitted herein.

In the optical scanner according to the third embodiment of the present invention, the stage 220 is horizontally driven in the second direction (Y direction) by an electrostatic force between the first driving comb electrodes 223 and the first comb electrodes 251. Here, the first bending spring 222 is deformed in the second direction (Y direction). Also, the driving frame and the stage 220 are horizontally driven in the first direction (X direction) by an electrostatic force between the third driving comb electrodes 243 and the third fixed comb electrodes 291. Here, the third bending spring 252 is deformed in the first direction.

For example, when a predetermined voltage is applied to the first fixed comb electrodes 251 disposed at the upper side of the drawing, an electrostatic force is generated between the first driving comb electrodes 223 and the first fixed comb electrodes 251 so that the first driving comb electrodes 223 are driven and thus the stage 220 is moved upward. When a predetermined voltage is applied to the first fixed comb electrodes 251 disposed at the lower side of the drawing, the stage 220 is moved downward. The stage 220 is returned to its original position by a restoration force by an elastic force of the first bending spring 222. By repeatedly applying a driving voltage to the first fixed comb electrodes 251 at the upper and lower sides to alternately generate an electrostatic force, the stage 220 performs an excitation motion with a predetermined frequency.

When a predetermined tuning voltage is simultaneously applied to the second fixed comb electrodes 241 separated from the opposite sides of the stage 220, a force to pull the first inertia portion 230 toward the second portions 240 of the driving frame is generated in the first inertial portion 230. Accordingly, the spring constant (stiffness) of the first bending spring 222 increases. Thus, by controlling the tuning voltage, the excitation frequency of the stage 220 can be set to be a resonant frequency.

Although in the above embodiment the stage 220 is horizontally driven, when a single first bending spring is installed and a driving voltage is applied to the first fixed comb electrodes 251 while an external force is applied to make the stage 220 perform a seesaw motion, the stage 220 performs a seesaw motion around the first bending spring as a center shaft. The frequency of the stage 220 is tunable by applying a tuning voltage to the second fixed comb electrodes 241. Also, when a single third bending spring is installed and a driving voltage is applied to the third fixed comb electrodes 291 while an external force is applied to make the driving frame perform a seesaw motion, the driving frame and the stage 220 perform seesaw motions around the third bending spring as a center shaft. The excitation frequency of the stage 220 in the first direction is tunable by applying a tuning voltage to the fourth fixed comb electrodes 281.

As described above, in the optical scanner according to the present invention, the constant of the bending spring supporting the stage is increased by applying a tuning voltage. Thus, the frequency to drive the stage increases so as to be used as a resonant frequency. Accordingly, the driving angle of the optical scanner driven by the resonant frequency can be increased and the driving voltage of the stage can be reduced.

While this invention has been particularly shown and described with reference to preferred embodiments thereof, it will be understood by those skilled in the art that various changes in form and details may be made therein without departing from the spirit and scope of the invention as defined by the appended claims.

1. A one-axis driving optical scanner comprising:
a substrate;
a stage separated a predetermined height from the substrate and having an optical scanning surface formed on an upper surface thereof;
a plurality of first driving comb electrodes extending from opposite sides of the stage;
a first anchor separated a predetermined distance from the opposite sides of the stage and fixed on the substrate and having a plurality of first fixed comb electrodes arranged at one side thereof to be alternate with the first driving comb electrodes;
at least one first bending spring having one end connected to a center portion of each of another opposite sides of the stage;
an inertia portion separated a predetermined distance above the substrate, in which the other end of the first bending spring is connected to a center portion of one side thereof;
a second anchor fixed on the substrate at opposite sides of the first anchor;
a second bending spring connecting the inertia portion and the second anchor; and
an inertia portion pulling unit to pull the inertia portion in a direction opposite to the first bending spring.

2. The optical scanner as claimed in claim 1, wherein the inertia portion pulling unit comprises:
a third anchor fixed on the substrate to be separated a predetermined distance from the inertia portion;
a plurality of second driving comb electrodes extending a predetermined length from the inertia portion toward the third anchor; and
a plurality of second fixed comb electrodes formed at the third anchor to be alternate with the second driving comb electrodes.

3. The optical scanner as claimed in claim 2, further comprising a voltage supply source to simultaneously apply a predetermined tuning voltage to the second fixed comb electrodes formed at the opposite sides of the stage.

4. The optical scanner as claimed in claim 3, wherein, when a predetermined tuning voltage is applied to the voltage supply source, a spring constant of the first bending spring increases.

5. The optical scanner as claimed in claim 1, wherein the first bending spring has a plate shape in which a vertical length is greater than a horizontal width.

6. The optical scanner as claimed in claim 1, wherein the first and second anchors are electrically separated from each other.

7. The optical scanner as claimed in claim 6, wherein the first, second, and third anchors constitute a rectangular frame and are electrically separated from one another.

8. A one-axis driving optical scanner comprising:
a substrate;
a stage separated a predetermined height from the substrate and having an optical scanning surface formed on an upper surface thereof;
a plurality of first driving comb electrodes extending from opposite sides of the stage;
a first anchor separated a predetermined distance from the opposite sides of the stage and fixed on the substrate and having a plurality of first fixed comb electrodes arranged at one side thereof to be alternate with the first driving comb electrodes;
at least one first bending spring having one end connected to a center portion of each of another opposite sides of the stage;
an inertia frame separated a predetermined distance above the substrate, in which the other end of the first bending spring is connected to one side thereof, and having at least two inertia portions separated from each of another opposite sides of the stage parallel to each other and a support beam connecting between the inertia portions;
a second anchor fixed on the substrate to correspond to the inertia frame from opposite sides of the first anchor;
a second bending spring connecting the inertia portion and an inner side of the second anchor corresponding to opposite sides of each of the inertia portions; and
an inertia portion pulling unit to pull the inertia frame in a direction opposite to the first bending spring.

9. The optical scanner as claimed in claim 8, wherein the inertia frame pulling unit comprises:
a third anchor fixed on the substrate to be separated a predetermined distance from the inertia frame at an opposite side of the stage with respect to the inertia frame;
an anchor branch fixed on the substrate to extend from the inner side of the second anchor toward the support beam;
a plurality of second driving comb electrodes extending a predetermined length from the inertia portions toward a direction opposite to the stage; and
a plurality of second fixed comb electrodes formed on the third anchor and the anchor branch, corresponding to the second driving comb electrodes, to be alternate with the second driving comb electrodes.

10. The optical scanner as claimed in claim 9, further comprising a voltage supply source to simultaneously apply a predetermined tuning voltage to the second fixed comb electrodes formed at the opposite sides of the stage.

11. The optical scanner as claimed in claim 10, wherein, when a predetermined tuning voltage is applied to the voltage supply source, a spring constant of the first bending spring increases.

12. The optical scanner as claimed in claim 8, wherein the first bending spring has a plate shape in which a vertical length is greater than a horizontal width.

13. The optical scanner as claimed in claim 8, wherein the first and second anchors are electrically separated from each other and the inertia portion and the anchor branch are electrically insulated from each other.

14. The optical scanner as claimed in claim 13, wherein the first, second, and third anchors constitute a rectangular frame and are electrically separated from one another.

15. A two-axes driving optical scanner comprising:
a substrate;
a stage separated a predetermined height from the substrate and having an optical scanning surface formed on an upper surface thereof;
a first support portion supporting a linear motion of the stage and including at least one first bending spring extending from opposite sides of the stage in a first direction, a first inertia portion having one side connected to the first bending spring, and a rectangular driving frame having a pair of first portions parallel to each other, to which a second bend spring extending from the other opposite sides of the first inertia portion in a second direction perpendicular to the first direction is connected, and a pair of second portions extending in the second direction parallel to each other;
a stage driving portion including a plurality of first fixed comb electrodes and first driving comb electrodes formed at inner sides of the first portions and corresponding side of the stage, respectively;
a second support portion including a third bending spring extending from each of the first portions of the driving frame in the second direction, a second inertia portion having one side connected to the third bending spring, and a rectangular fixed frame having a pair of second portions parallel to each other, to which a fourth bend spring extending from the other opposite sides of the second inertia portion in the first direction is connected, and a pair of first portions extending in the first direction parallel to each other;
a first support portion driving portion including a plurality of third driving comb electrodes provided at the second portions of the driving frame and a plurality of third fixed comb electrodes formed at inner sides of the first portions of the fixed frame corresponding to the third driving comb electrodes, to generate a first directional excitation motion of the first support portion; and
first and/or second inertial portions pulling unit to pull the first inertia portion and/or the second inertia portion in a direction opposite to the stage.

16. The optical scanner as claimed in claim 15, wherein the first inertia portion pulling unit comprises:
a plurality of second driving comb electrodes formed at a side of the first inertia portion facing the second portion of the driving frame; and
a plurality of second fixed comb electrodes formed at the driving frame to be alternate with the second driving comb electrodes.

17. The optical scanner as claimed in claim 16, further comprising a voltage supply source to simultaneously apply a predetermined tuning voltage to the second fixed comb electrodes formed at the opposite sides of the stage.

18. The optical scanner as claimed in claim 17, wherein, when a predetermined tuning voltage is applied to the voltage supply source, a spring constant of the first bending spring increases.

19. The optical scanner as claimed in claim 15, wherein the first bending spring has a plate shape in which a vertical length is greater than a horizontal width.

20. The optical scanner as claimed in claim 15, wherein the second inertia portion pulling unit comprises:
a plurality of fourth driving comb electrodes formed at a side of the second inertia portion facing the first portion of the fixed frame; and
a plurality of fourth fixed comb electrodes formed at the fixed frame to be alternate with the fourth driving comb electrodes.

21. The optical scanner as claimed in claim 20, further comprising a voltage supply source to simultaneously apply a predetermined tuning voltage to the fourth fixed comb electrodes formed at the opposite sides of the stage.

22. The optical scanner as claimed in claim 21, wherein, when a predetermined tuning voltage is applied to the voltage supply source, a spring constant of the third bending spring increases.

23. The optical scanner as claimed in claim 15, wherein the third bending spring has a plate shape in which a vertical length is greater than a horizontal width.
